(19) United States
(12) Patent Application Publication
(10) Pub. No.: US 2007/0116295 A1
(43) Pub. Date: May 24, 2007

(54) System and method for real time emulation of communication systems

(76) Inventors: Jan Vandewege, Mariakerke (BE); Jo Pletinckx, Grossbottwar (DE); Koen Van Renterghem, Gent (BE); Xing-Zhi Qiu, Wondelgem (BE)

Correspondence Address: KNOBBE MARTENS OLSON & BEAR LLP, 2040 MAIN STREET, FOURTEENTH FLOOR, IRVINE, CA, 92614, US

(21) Appl. No.: 11/595,838

(22) Filed: Nov. 9, 2006

Related U.S. Application Data
(60) Provisional application No. 60/735,538, filed on Nov. 10, 2005.

(51) Int. Cl. H04R 5/00

(52) U.S. Cl. 381/17

(57) ABSTRACT

One inventive aspect relates to an emulation system for real-time simulation of the physical layer of an analog communication system based at least on partly digital computation. The emulation system comprises a digital portion configured to perform digital computations and represent at least part of the signal propagation in the communication system. The system further comprises an analog portion configured to perform analog signal processing and represent other aspects of the physical layer of the communication system. The analog portion provides inputs to and receives outputs from the digital portion. The digital portion is configured to digitally compensate for inaccuracies introduced by the analog portion. Methods of emulating communication systems are also provided.

### CROSS-REFERENCE TO RELATED APPLICATIONS

Claim of Priority Under 35 U.S.C. §119

This application claims priority under 35 U.S.C. Section 119(e) to U.S. Provisional Patent Applications 60/735,538 entitled “SYSTEM AND METHOD FOR THE REAL TIME EMULATION OF COMMUNICATION SYSTEMS” filed on Nov. 10, 2005, which is incorporated by reference in its entirety.

### BACKGROUND OF THE INVENTION

1. Field of the Invention

The invention relates to a system and method for real-time emulations (also denoted hard real-time simulation) of communication systems, in particular those modeled as networks, and in particular transmission line networks.

2. Description of the Related Technology

Several characteristics of the physical layer of a communication system, such as attenuation, dispersion, crosstalk, noise and others may affect the system performance. A method to accurately emulate communication systems in real time is a valuable asset in the development, certification and benchmarking of communications equipment.

Classic analog emulation techniques exist and allow emulating twisted pair cabling.

### SUMMARY OF CERTAIN INVENTIVE ASPECTS

The physical layer of communication systems can be modeled as a transmission line topology or network. Certain inventive aspects provide methods to accurately emulate such a topology in real time.

The methods presented allow to emulate true real-time behavior, even for very short networks.

In inventive aspects, most of the signal processing is performed by digital electronics. This innovative approach results in an extraordinary accuracy and reconfigurability, and stands in sheer contrast with traditional emulation in analog hardware.

Aspects of the system and method can be used for emulating twisted pair networks for xDSL, can be applied for the emulation of a wide range of linear network topologies and lines, and in the design of other time-critical systems. The transmission lines, their interconnects and terminations can be physical (twisted pair, coax, optical fiber, waveguides), or virtual, merely describing the propagation of (wave) energy along a path or mode (a wireless propagation path, a waveguide mode or optical fiber mode). The methods can be used to emulate the physical layer of almost any essentially linear system.

One inventive aspect relates to a digital emulator which offers several advantages such as:

Reconfigurability: The capability to reconfigure the platform, allows to accommodate for a wide range of topologies consisting of several parts with different length, characteristic impedance en propagation function and even add new models without making labor intensive hardware modifications. The filter core in fact is quite generic, offering emulation of bidirectional propagation and filtering over a wide bandwidth and high dynamic range combined with precise delay increments. Its reconfigurable nature combined with a high performance analog front-end, results in a versatile platform suitable for a wide range of applications.

Reproducibility: A digital core produces consistent results over a prolonged time period and is not prone to aging and environmental influences as are analog designs. However, the necessary conversion to and from the analog domain reduces the deterministic character. In-system calibration procedures compensate for the introduced inaccuracies, without any modification to the actual hardware platform, as the compensation is performed digitally.

Delay Emulation: The correct emulation of group delay (true phase) of the transmission medium is important. Advanced communication systems typically use one or more mechanisms to compensate for the frequency-dependent characteristics of the transmission medium, commonly called equalizers. From a digital perspective, group delay can be emulated efficiently using delay lines, supporting very long delays, whilst maintaining a fine granularity. Analog delay lines, although feasible, cannot achieve the same combination of flexibility and range.

Time variant, fading channels: An important parameter of a communication system is its stability against channel variations. This impairment is typically observed in wireless communications but also exists in the telephone access network. Temperature variations affect the primary loop characteristics, especially the resistance per unit length and, to a lesser degree, the inductance per unit length.

Channel Disturbers: Channel disturbers such as impulse noise, crosstalk or others can be easily digitally injected in a reproducible way.

In one inventive aspect, to achieve these goals a novel system architecture consisting of a digital core and specific analog subsystems was created. Its architecture is unique, and based on a careful usage of the available time budget resulting from transmission line propagation delays which are in the nanosecond area for typical cables. The non-zero computational delay of each building element puts a hard limit on the minimal test loop length, and necessitates an innovative approach. Methods are provided to
1. compensate for non-zero processing delay of digital subsystems in the digital processing core and allow for true delay emulation over a wide range of delay values, with a low minimum delay limit.
2. digitally compensate the characteristics of the analog subsystems, in the digital processing core.
3. perform self-calibration of the instrument
4. allow for the emulation of time-variable parameters in a continuous mode.
5. allow for injection of noise and disturbing signals and the emulation of crosstalk without disturbing the digital computations.
6. handle frequency conversions.

In one aspect, there is a system for real-time emulation (hard real-time simulation) of a communication system, represented as a network, the system comprising: a digital processor, two analog/digital digital/analog converters, two analog reflection modules and a DC loop emulation part, wherein said digital processing performs signal processing as an essential part of the emulation calculations.

The use of a distributed system has the important advantage that termination impedance mismatch and energy loss through propagation are under control of distinct entities or modules and that emulation thereof can be handled by different entities or modules, and even in different domains.

At least the propagation effects on the network transmission lines are emulated in a digital processing core. By this hybrid approach, fully bidirectional physical layer emulation is achieved within the bandwidth of the system.

In an embodiment, the digital processor is a hardware reconfigurable core, e.g. an FPGA.

In an embodiment, the digital processor further performs signal processing for digital compensating the characteristics of one or more of the other components of the apparatus (two analog/digital digital/analog converters, two analog reflection modules and a DC loop emulation part).

In another aspect, the invented real-time emulation (hard real-time simulation ) of a communication system, represented as a network, comprising of various transmission line elements, with a system comprising: a digital processor, two analog/digital digital/analog conversion means, two analog reflection modules and a DC loop emulation part, exploits a method of careful usage/spreading of the available time budget resulting from transmission line propagation delays over the parts of the apparatus, to account for the non-zero computational delay of said parts.

A characteristic of certain embodiments is that an automated approach to derive such usage/spreading in a sort of self calibration approach is provided.

In particular an approach to configure the digital core, such that for at least part of the network transmission line elements, a digital subsystem within said digital core is assigned, contributes to a time-budget controlled approach.

One inventive aspect relates to an emulation system, for real-time simulation of the physical layer of an analog communication system based at least on partly digital computation. The at least two-ported emulation system comprises a digital portion configured to perform digital computations and represent at least part of the signal propagation in the communication system, and an analog portion configured to perform analog signal processing and represent other aspects of the physical layer of the communication system, the analog portion providing inputs to and receiving outputs from the digital portion. The digital portion is configured to digitally compensate for inaccuracies introduced by the analog portion. Another inventive aspect relates to a method of automated software controlled calibrating an emulation system which comprises a digital portion and an analog portion. The method comprises measuring inaccuracies of the analog portion, determining the compensation to be performed by the digital portion for the inaccuracies, and programming the digital portion with the compensation by reconfiguring at least part of the digital portion.

Another inventive aspect relates to a method of programming a two-ported emulation system adapted for real-time simulation of communication system based at least on partly digital computation. The communication system comprising a plurality of system blocks. The emulation system comprises a digital portion which comprises digital subsystems. The method comprises determining the total delay between at least two endpoints of the communication system, determining differences between the needed computational time of the emulation system and the actual propagation delay for each of the system blocks in between the endpoints, and programming the emulation system by modifying the computational times in order to distribute the differences over the digital subsystems such that the total delay approximately equals the sum of the modified computational times.

Another inventive aspect relates to a method of real-time simulations of a communication system with an emulation system based at least on partly digital computation. The method comprises calibrating the emulation system, programming the emulation system, and determining the simulated response of the communication system on provided inputs with the emulation system.

### BRIEF DESCRIPTION OF THE DRAWINGS

FIG. 1 shows the modular equivalent of a transmission line. The structure contains two reflection modules and one propagation module.

FIG. 2 shows an example of a decomposition of a line topology into building blocks (lines, nodes, terminations).

FIG. 3 shows an embodiment of the main system building blocks of a two-port digital emulator: two reflection modules, AD/DA conversion steps, the digital core and a DC emulation path. The necessary anti-alias and reconstruction filters are omitted for clarity.

FIG. 4 shows the same topology as FIG. 2, but with the addition of signal injection/extraction blocks.

FIG. 5 illustrates functional blocks of an embodiment of the emulation system.

### DETAILED DESCRIPTION OF CERTAIN INVENTIVE EMBODIMENTS

As a motivating example, reference is made to copper pair networks, which were designed for voice traffic, but xDSL technologies such as HSDL, ADSL, T1, E1, VDSL, etc. and may exceed voice bandwidth more than a thousand fold. The efficient exploitation of copper pair access networks at high bandwidth therefore presents a formidable challenge, and the capability of accurately analyzing and emulating specific access line cables and topologies has therefore become quite important. Certain inventive embodiments as described herein are, of course, not limited to these types of communication networks.

In order to address these issues, a digital subscriber line emulator was designed. Once it is configured, the instrument behaves almost exactly as the network it was configured to emulate, so it can be used in the characterization and testing of high-grade communication equipment. The emulation of bidirectional subscriber loops at megahertz frequencies is not straightforward, as complex phenomena needs to be dealt with, such as frequency dependent characteristic impedance and transmission, DC loop impedance, propagation delay, reflections caused by mismatch at the terminations and at intra-loop line fuses, crosstalk, noise and line faults.

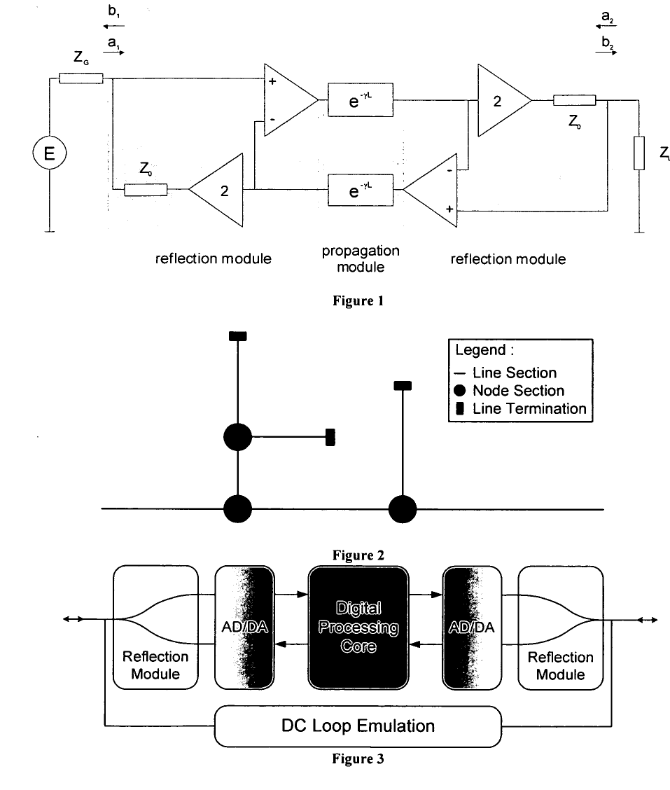

A lossy linear transmission line can be described by three parameters: its characteristic impedance Z₀, the exponential wave propagation function γ(ω) and its length L. Such a transmission line can be emulated exactly with a system that decomposes the line behavior into the exponential wave propagation function and its characteristic impedance as show in FIG. 1.

The equivalence of both structures can also be shown by deriving the scattering matrix S^{eq} of the two-port system in FIG. 1, in base Z₀. The circuit is symmetric and therefore S₂₂^{eq}=S₁₁^{eq} and S₁₂^{eq}=S₂₁^{eq}. The scattering parameters S₁₁^{eq} and S₂₁^{ez} are easily determined using

$${S}_{11}^{eq} ( ω ) = \frac{{b}_{1}}{{a}_{1}} {\vert}_{{a}_{2} = 0} \\ {S}_{21}^{eq} ( ω ) = \frac{{b}_{2}}{{a}_{1}} {\vert}_{{a}_{2} = 0}$$

The equivalent transmission line network is terminated in its characteristic impedance, Z₀. As V₂−V₁=0, no reflections are generated and hence, b₁=0. Thus, it follows that S₁₁^{eq}(ω)=0. Similarly, b₂ is derived as
Such that

$${b}_{2} = \frac{2 {Z}_{0}}{{Z}_{0} + {Z}_{0}} {ⅇ}^{- γ L} {a}_{1}$$

$${S}_{21}^{eq} ( ω ) = {ⅇ}^{- γ L}$$

This decomposition has the important advantage that termination impedance mismatch and energy loss through propagation are under control of two distinct entities and that emulation thereof can be handled by different modules, and even in different domains. In the apparatus, the hybrid does not only account for the wave separation, but also for the emulation of the characteristic impedance of the outer line sections in analog hardware, as the reflections due to characteristic impedance mismatch between a cable end and the source driving the cable are instantaneous and cannot be emulated digitally. The propagation effects on the network transmission lines however, and all other physical layer characteristics of the network, are emulated in a digital processing core. By this hybrid approach, fully bidirectional physical layer emulation is achieved within the bandwidth of the system with unprecedented accuracy, reproducibility and flexibility.

The simple model presented above can be expanded to include cascades and bridged taps, by replacing the simple propagation module with a more complex entity, which not only emulates the propagation through the constituting lines, but also the internal reflections at the junctions. And linear networks with more than two input/outputs (multiport networks) can be handled as well.

The digital processing core consists of dedicated building blocks, each representing an element of a transmission line topology. The main building blocks are line sections, node sections and line terminations. The line sections emulate the frequency dependant propagation function along a transmission line, while node sections emulate the effects of characteristic impedance mismatch between line sections. Reflections due to the mismatch between a line and its (complex) termination impedance are emulated in a line termination building block (FIG. 2).

An overview of a suitable embodiment of a system architecture to emulate the physical layer of a linear network using hard real time digital signal processing techniques combined with specific analog subsystems is shown in FIG. 3.

The DC component of the signal is subtracted and the waves propagating left and right on the transmission medium are separated (and combined) in a hybrid structure and then digitized in an AD/DA block. The DC component of the signal, which could be significant in the case of remote power feeding, is emulated in a separate signal processing path emulating the DC cable losses.

The system architecture of a digital emulator, as described above can be extended for the emulation of time varying effects, for example temperature effects on cables, by making the coefficients in-system reconfigurable without disturbing the ongoing signal processing.

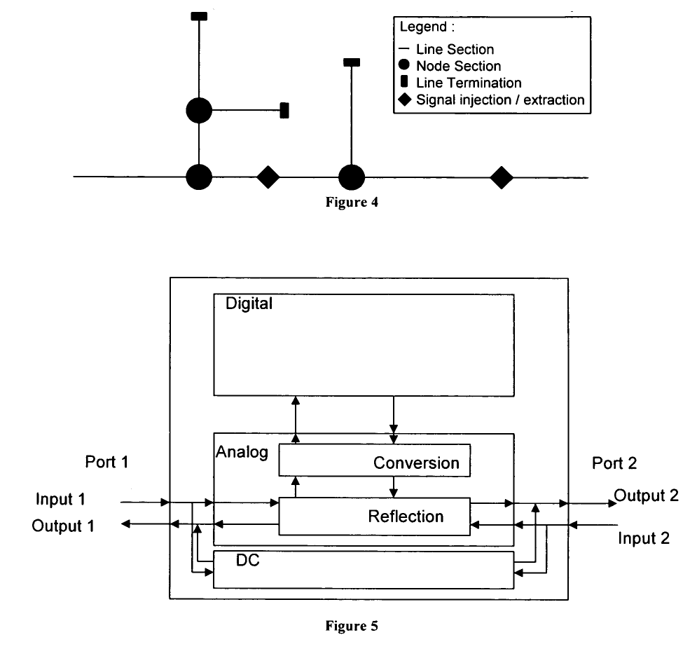

A second feature that can be added is the possibility to inject impairment signals in the digital domain or to monitor (extract) signal levels at an arbitrary location in the topology in a non intrusive way compared to analog signal injection or monitoring (FIG. 4). This method can be used to emulate or measure the effects of crosstalk or any other impairment.

Apart from passive transmission lines, the architecture under discussion can be used to emulate any linear network within a given budget of dynamic range, bandwidth and time. The node sections can be regarded as matching networks, while lines represent the behavior of a 2-port network with matched source and load impedance. From this observation, it is clear that the line sections can be used for active, passive, lumped and/or distributed 2-port elements.

The design of an emulator with absolute phase (delay) accuracy demands careful usage of the available time budget. In twisted pair cabling, signals travel at roughly 2*10⁸ m/s, limiting the total time budget available for the complete emulation cycle to about 5 ns per meter of line length. The non-zero computational delay of each building element puts a hard limit on the minimal test loop length, as it is balanced by at least an equal amount of topology group delay. Consider a cascade of two lines, joined by a non-trivial node section and consider a signal that propagates through a first section, reflects on the splice and propagates back through the same section. If the computation time of the node and the two line sections is larger than the time it takes for the signal to travel in a real cable, correct emulation of the group delay is impossible. In order to emulate the group delay of the emulated topology and composing elements truthfully, the processing delay should be absorbed in the filter models. For lines, the processing delay can be compensated for in the associated delay line, which is responsible for the constant part of the group delay of the line section. The implementation of nodes and terminations poses a problem, as reflections occur instantaneously. Clearly, the configurable delay lines will have to be adjusted to compensate for this as well.

A set of boundary conditions to solve this problem can be derived from the observation that for any possible signal path between all endpoints of the topology the delay should be exact to obtain a correct phase and group delay. This means that the accumulated processing delay of instantaneous building blocks on each path should be compensated for by subtracting this delay in one or several other non-instantaneous building blocks.

The resulting set of conditions can be split into two subsets: one describing how the delays should be compensated and a second one that specifies a relationship between the different non-zero processing delays, necessary to obtain a solution. If this relationship is obeyed, more than one solution generally exists to the compensation problem.

Apart from using this method to compensate processing delays, the same reasoning can be used to redistribute delay through the system or to compensate the characteristics (phase and magnitude) of system blocks outside of the digital processing core.

In one embodiment, in order to measure these characteristics a self-calibration technique was used. The digital processing core, which is connected to two ADCs and two DACs is reconfigured to measure the phase and magnitude characteristics for a number of frequencies on selected signal paths starting at a DAC and ending at an ADC, providing network analyzer like functionality. Once all necessary information is gathered, the compensation values can be calculated and incorporated in the digital processing core, thus enhancing the system accuracy.

FIG. 5 illustrates functional blocks of an embodiment of the emulation system. The emulation system comprises a digital portion, an analog portion, both portions communicating with each other. The emulation system has at least two ports, each defined here functionally as an input and output. The inputs/outputs are connected to the analog portion, not to the digital portion. The inputs/outputs are also connected in a direct way with the DC portion. Note that FIG. 5 illustrates functional blocks of the embodiment. In reality simulation input signals may be provided and the resulting output signals may be recorded. In one embodiment the emulation system is incorporated within a context with real communication device and directly coupled thereto. FIG. 5 further shows a possible structure of the analog portion, comprising a conversion and reflection module. Note that each of the conversion module and reflection module may further comprise separate modules, for example, as many as there are ports.

In summary, inventive aspects may include the following.

A method, allowing compensating for non-zero computational delays in a digital hard real time signal processing system. An apparatus, implementing the method as described above. An apparatus, as described above, allowing real time digital emulation of a linear network with passive, active, lumped and/or distributed elements. An apparatus, as described above, allowing the emulation of networks containing network elements with time varying characteristics through in-system alteration of filter coefficients during the emulation, without disrupting the system or creating erroneous signals at the emulator terminals. An apparatus, as defined above, allowing arbitrary signal injection into one or more locations in the network topology during emulating, and without any disturbance of other network parameters that are emulated. An apparatus, as defined above, allowing signal extraction from one or more locations within the emulated network without any disturbance of the network parameters that are emulated. An apparatus, as defined above, using the available system hardware to characterize system signal paths. An apparatus, as described above, allowing real time digital emulation of an optical network topology.

Note that with the simulation of the physical layer of an analog communication system is meant the port-to-port behavior of such system. Further with analog communication system is meant a network, a device or instrumentation with analog input and output ports, or a set-up with combinations of such networks, devices and instrumentation.

While the above detailed description has shown, described, and pointed out novel features of the invention as applied to various embodiments, it merely illustrates the principles of the invention. It will be understood that various omissions, substitutions, and changes in the form and details of the device or process illustrated may be made by those skilled in the technology without departing from the spirit of the invention. The scope of the invention is indicated by the appended claims rather than by the foregoing description. All changes which come within the meaning and range of equivalency of the claims are to be embraced within their scope.

Finally, although systems and methods as disclosed, is embodied in the form of various discrete functional blocks, the system could equally well be embodied in an arrangement in which the functions of any one or more of those blocks or indeed, all of the functions thereof, are realized, for example, by one or more appropriately programmed processors or devices.

1. An emulation system, for simulation of the physical layer of an analog communication system, the emulation system comprising:
a digital portion configured to perform digital computations and represent at least part of the signal propagation in the communication system; and
an analog portion configured to perform analog signal processing and represent other aspects of the physical layer of the communication system, the analog portion providing inputs to and receiving outputs from the digital portion;
wherein the digital portion is configured to digitally compensate for inaccuracies introduced by the analog portion.

2. The emulation system as in claim 1, wherein the digital portion is further configured to represent energy loss through propagation and/or internal reflections of the communication system, and the analog portion further comprises:
a conversion module configured to at least provide conversions between the analog and digital domain, the analog portion converting inputs to and outputs from the digital portion; and
an analog reflection module configured to provide inputs to and receive outputs from the conversion module, and to represent termination impedance mismatch of the communication system.

3. The emulation system of claim 1, wherein the digital portion comprises a programmable processor.

4. The emulation system of claim 1, wherein the digital portion comprises software-reconfigurable hardware.

5. The emulation system of claim 4, wherein the software-reconfigurable hardware comprises an FPGA.

6. The emulation system of claim 1, wherein the digital portion is configured to represent bi-directional propagation.

7. The emulation system of claim 1, wherein the digital portion is further configured to represent changes in signal amplitude, phase and/or delay caused by propagation within the communication system.

8. The emulation system of claim 7, wherein the digital portion is configured to represents the delays with digital delay lines.

9. The emulation system of claim 1, further comprising at least two ports and an analog DC emulation portion configured to directly connect the at least two ports.

10. A method of calibrating an emulation system comprising a digital portion and an analog portion, the method comprising:
measuring inaccuracies of the analog portion;
determining compensation to be performed by the digital portion for the inaccuracies; and
programming the digital portion with the compensation by reconfiguring at least part of the digital portion.

11. The method as in claim 10, wherein the measuring comprises generating test signals for measuring the inaccuracies of the analog portion.

12. The method as in claim 11, wherein the generating of test signals comprises reconfiguring a part of the digital portion to enable the part to generated the test signals.

13. A computer-readable medium having stored thereon instructions configured to cause a processing device to perform the method of claim 10.

14. A method of programming an emulation system adapted for real-time simulation of a communication system comprising a plurality of system blocks, the emulation system comprising a digital portion which comprises digital subsystems, the method comprising:
determining the total delay between at least two endpoints of the communication system;
determining differences between the needed computational time of the emulation system and the actual propagation delay for each of the system blocks in between the endpoints; and
programming the emulation system by modifying the computational times in order to distribute the differences over the digital subsystems such that the total delay approximately equals the sum of the modified computational times.

15. The method of claim 14, wherein the programming comprises changing the reconfiguration of at least a part of the digital portion.

16. A computer-readable medium having stored thereon instructions configured to cause a processing device to perform the method of claim 14.

17. A method of real-time simulating a communication system comprising a plurality of system blocks with an emulation system based at least on partly digital computation, the emulation system comprising a digital portion and an analog portion, the digital portion comprising digital subsystems the method comprising:
calibrating the emulation system in accordance with a method of calibrating an emulation system, the method comprising:
measuring inaccuracies of the analog portion;
determining compensation to be performed by the digital portion for the inaccuracies; and
programming the digital portion with the compensation by reconfiguring at least part of the digital portion;
programming the emulation system in accordance with a method of programming the emulation system, the method comprising:
determining the total delay between at least two endpoints of the communication system;
determining differences between the needed computational time of the emulation system and the actual propagation delay for each of the system blocks in between the endpoints; and
programming the emulation system by modifying the computational times in order to distribute the differences over the digital subsystems such that the total delay approximately equals the sum of the modified computational times; and
determining the simulated response of the communication system on provided inputs with the emulation system.

18. A computer-readable medium having stored thereon instructions configured to cause a processing device to perform the method of claim 17.
